(19) United States
(12) Patent Application Publication
(10) Pub. No.: US 2024/0297383 A1
(43) Pub. Date: Sep. 5, 2024

(54) SYSTEMS AND METHODS FOR SEALING INTERFACES OF TRACTION BATTERY PACKS

(71) Applicant: FORD GLOBAL TECHNOLOGIES, LLC, Dearborn, MI (US)

(72) Inventor: Xiaogang Zhang, Novi, MI (US)

(21) Appl. No.: 18/176,776

(22) Filed: Mar. 1, 2023

(51) Int. Cl. H01M 50/186; H01M 50/262

(52) U.S. Cl. CPC H01M 50/186; H01M 50/262; H01M 2220/20

(57) ABSTRACT

Systems and methods are provided for sealing interfaces of a traction battery pack. A gasket seal may be arranged to seal an interface between a first enclosure section and a second enclosure section of an enclosure assembly of the traction battery pack. The gasket seal may be disposed within a pocket that is isolated from an interior area of the traction battery pack. A fastener (e.g., spot weld, adhesive, or both) may isolate the gasket seal from the interior area.

### TECHNICAL FIELD

This disclosure relates generally to electrified vehicle traction battery packs, and more particularly to sealing interfaces of a traction battery pack.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, an enclosure assembly including a first enclosure section and a second enclosure section, and a gasket seal arranged within a pocket between a first peripheral flange of the first enclosure section and a second peripheral flange of the second enclosure section. The pocket is isolated from a gas path that extends between the first peripheral flange and the second peripheral flange.

In a further non-limiting embodiment of the foregoing traction battery pack, a fastener isolates the pocket from the gas path.

In a further non-limiting embodiment of either of the foregoing traction battery packs, the fastener includes a spot weld, an adhesive, or both.

In a further non-limiting embodiment of any of the foregoing traction battery packs, the first peripheral flange at least partially envelops the second peripheral flange.

In a further non-limiting embodiment of any of the foregoing traction battery packs, the first peripheral flange includes a first horizontal shield portion, a second horizontal shield portion, and a vertical shield portion that connects between the first horizontal shield portion and the second horizontal shield portion, and the second peripheral flange includes a horizontal shield portion and a vertical shield portion that extends from the horizontal shield portion.

In a further non-limiting embodiment of any of the foregoing traction battery packs, the first horizontal shield portion of the first peripheral flange extends over the horizontal shield portion of the second peripheral flange, and the second horizontal shield portion of the first peripheral flange extends beneath the vertical shield portion of the second peripheral flange.

In a further non-limiting embodiment of any of the foregoing traction battery packs, a fastener seals a flange-to-flange interface between the vertical shield portion of the second peripheral flange and the second horizontal shield portion of the first peripheral flange.

In a further non-limiting embodiment of any of the foregoing traction battery packs, an air gap is between the vertical shield portion of the first peripheral flange and the vertical shield portion of the second peripheral flange.

In a further non-limiting embodiment of any of the foregoing traction battery packs, the gasket seal is arranged on an opposite side of the vertical shield portion of the second peripheral flange from the air gap.

In a further non-limiting embodiment of any of the foregoing traction battery packs, the gas path extends between the first horizontal shield portion of the first peripheral flange and the horizontal shield portion of the second peripheral flange and then into the air gap.

In a further non-limiting embodiment of any of the foregoing traction battery packs, the gasket seal is arranged between the horizontal shield portion of the second peripheral flange and the second horizontal shield portion of the first peripheral flange.

In a further non-limiting embodiment of any of the foregoing traction battery packs, the first enclosure section is an enclosure cover, and the second enclosure section is an enclosure tray.

A traction battery pack according to another exemplary aspect of the present disclosure includes, among other things, an enclosure assembly including a first enclosure section and a second enclosure section that cooperate to establish an interior area, a battery array positioned within the interior area, a gasket seal arranged between a first peripheral flange of the first enclosure section and a second peripheral flange of the second enclosure section, and a fastener that isolates the gasket seal from the interior area.

In a further non-limiting embodiment of the foregoing traction battery pack, the fastener includes a spot weld.

In a further non-limiting embodiment of either of the foregoing traction battery packs, the fastener includes an adhesive.

In a further non-limiting embodiment of any of the foregoing traction battery packs, the gasket seal is received in a pocket that is isolated from a gas path that extends between the first peripheral flange and the second peripheral flange by the fastener.

In a further non-limiting embodiment of any of the foregoing traction battery packs, the first peripheral flange includes a first horizontal shield portion, a second horizontal shield portion, and a vertical shield portion that connects between the first horizontal shield portion and the second horizontal shield portion, and the second peripheral flange includes a horizontal shield portion and a vertical shield portion that extends from the horizontal shield portion.

In a further non-limiting embodiment of any of the foregoing traction battery packs, the first horizontal shield portion of the first peripheral flange extends over the horizontal shield portion of the second peripheral flange, and the second horizontal shield portion of the first peripheral flange extends beneath the vertical shield portion of the second peripheral flange.

In a further non-limiting embodiment of any of the foregoing traction battery packs, the fastener seals a flange-to-flange interface between the vertical shield portion of the second peripheral flange and the second horizontal shield portion of the first peripheral flange.

In a further non-limiting embodiment of any of the foregoing traction battery packs, the gasket seal is arranged on an opposite side of the vertical shield portion of the second peripheral flange from an air gap that extends between the vertical shield portion of the first peripheral flange and the vertical shield portion of the second peripheral flange.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack for an electrified vehicle.

FIG. 3 is an exploded view of the traction battery pack of FIG. 2.

FIG. 4 is a blown-up view of Area 4 of FIG. 2.

FIG. 5 is a cross-sectional view of section 5-5 of FIG. 4.

FIG. 6 schematically illustrates a sealing interface of a battery enclosure assembly during a deflection event of a traction battery pack.

FIG. 7 illustrates an exemplary arrangement of an enclosure assembly for isolating a gasket seal from an interior arear of a traction battery pack.

### DETAILED DESCRIPTION

This disclosure details systems and methods for sealing interfaces of a traction battery pack. A gasket seal may be arranged to seal an interface between a first enclosure section and a second enclosure section of an enclosure assembly of the traction battery pack. The gasket seal may be disposed within a pocket that is isolated from an interior area of the traction battery pack. A fastener (e.g., spot weld, adhesive, or both) may isolate the gasket seal from the interior area. These and other features are discussed in greater detail in the following paragraphs of this detailed description.

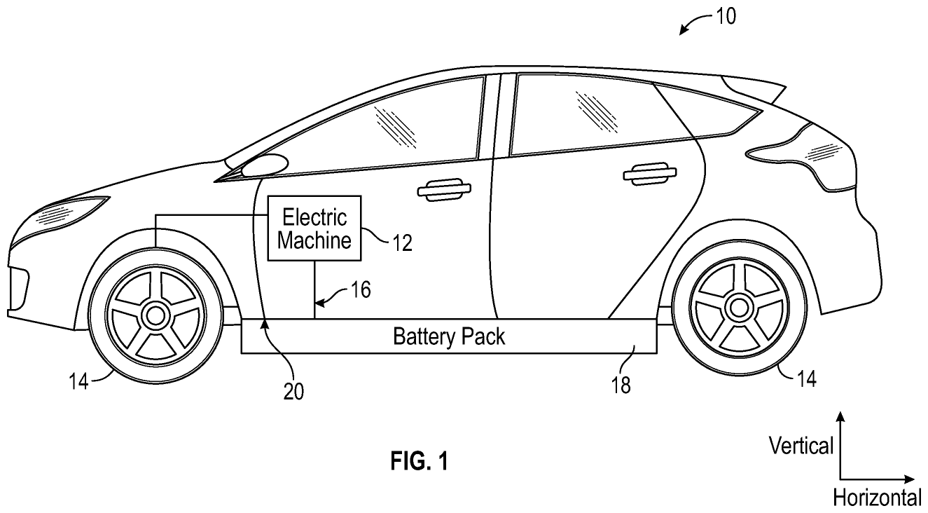

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

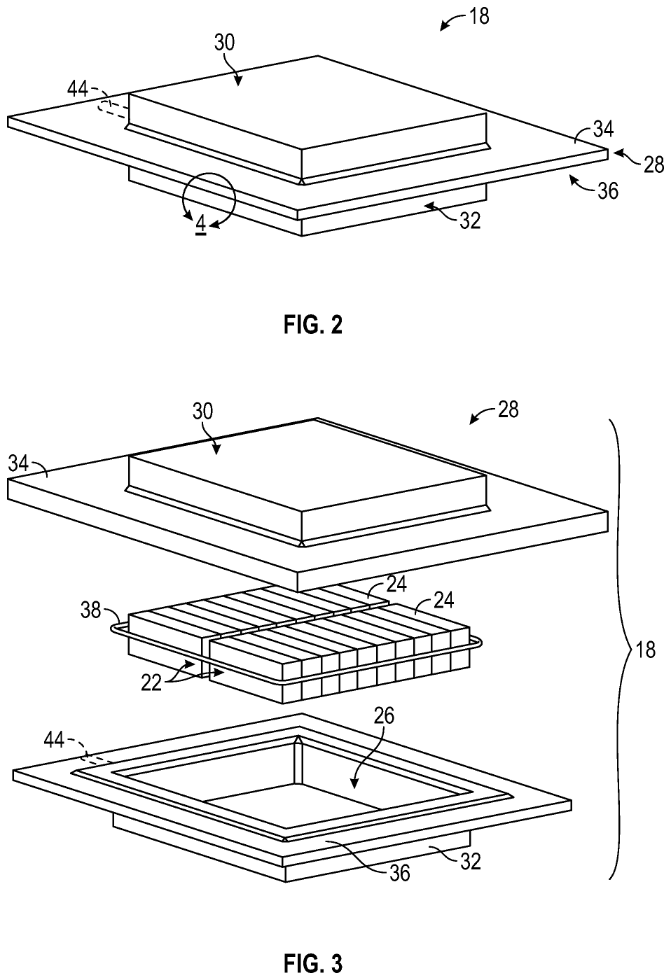

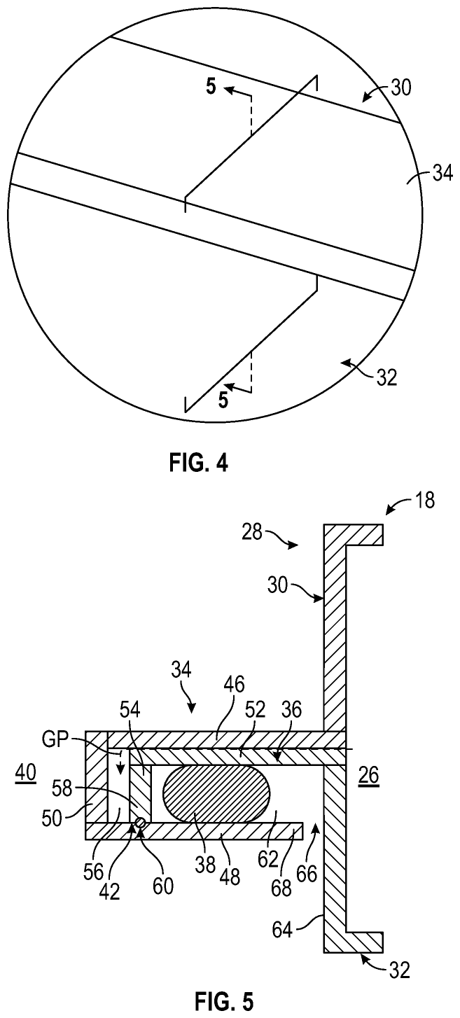

FIGS. 2, 3, and 4 illustrate additional details associated with the traction battery pack 18 of the electrified vehicle 10. The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10.

The battery cells 24 may be stacked side-by-side along a stack axis to construct a grouping of battery cells 24, sometimes referred to as a “cell stack.” The total number of battery arrays 22 and battery cells 24 provided within the traction battery pack 18 is not intended to limit this disclosure.

In an embodiment, the battery cells 24 of each battery array 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover 30 and an enclosure tray 32. The enclosure cover 30 may be secured (e.g., bolted, welded, adhered, etc.) to the enclosure tray 32 to provide the interior area 26. The size, shape, and overall configuration of the enclosure assembly 28 is not intended to limit this disclosure.

The enclosure cover 30 may include a first peripheral flange 34 that projects outward from the interior area 26, and the enclosure tray 32 may include a second peripheral flange 36 that projects outward from the interior area 26. The first peripheral flange 34 and the second peripheral flange 36 project horizontally in this example, but could project in other directions. Horizontal and vertical, for purposes of this disclosure, are with reference to ground in a general orientation of the traction battery pack 18 when installed on the electrified vehicle 10 of FIG. 1.

The enclosure cover 30 and the enclosure tray 32 may be metallic or metallic alloy structures. However, other materials or combinations of materials could be utilized within the scope of this disclosure. One or both of the enclosure cover 30 and enclosure tray 32 could be a stamping, an extruded component, or a diecast component, for example.

Referring now to FIG. 5, with continued reference to FIGS. 2-4, a gasket seal 38 or “sealing ring” may be disposed between the first peripheral flange 34 and the second peripheral flange 36. The gasket seal 38 may be arranged to extend circumferentially continuously about a perimeter of the interior area 26. The gasket seal 38 is configured to block moisture and contaminants from entering the interior area 26 from an ambient environment 40 outside of the traction battery pack 18.

The gasket seal 38 may be further arranged to be substantially isolated from the interior area 26 but still able to seal a gas exchange between the interior area 26 and the ambient environment 40. For example, if a battery thermal event in the interior area 26 results in increased thermal energy and vented gas, a flange-to-flange interface 42 between the first peripheral flange 34 and the second peripheral flange 36 of the enclosure assembly 28 may block vented gas and thermal energy from impinging directly on the gasket seal 38. This can help maintain the integrity of the gasket seal 38 and ensure that the vented gas and thermal energy is expelled from the interior area 26 at a desired area, such as through a vent port 44 (see FIGS. 2 and 3), for example.

The first peripheral flange 34 and the second peripheral flange 36 may cooperate to shield the gasket seal 38. In some implementations, the first peripheral flange 34 may at least partially surround, envelop, or wrap around the second peripheral flange 36 to shield the gasket seal 38 (see, e.g., FIG. 5). In other implementations, the second peripheral flange 36 may at least partially surround, envelop, or wrap around the first peripheral flange 34 to shield the gasket seal (see, e.g., FIG. 7).

The first peripheral flange 34 of the enclosure cover 30 may include a first horizontal shield portion 46, a second horizontal shield portion 48, and a vertical shield portion 50 that vertically connects between the first horizontal shield portion 46 and the second horizontal shield portion 48. The second peripheral flange 36 of the enclosure tray 32 may include a horizontal shield portion 52 and a vertical shield portion 54 that extends vertically away from the horizontal shield portion 52 (here, in a direction toward ground).

The first horizontal shield portion 46 of the first peripheral flange 34 may extend over the horizontal shield portion 52 of the second peripheral flange 36. The first horizontal shield portion 46 and the horizontal shield portion 52 may be arranged in direct contact with one another.

The vertical shield portion 50 of the first peripheral flange 34 may be positioned laterally outward of the vertical shield portion 54 of the second peripheral flange 36. An air gap 56 may extend between the vertical shield portion 50 and the vertical shield portion 54.

The second horizontal shield portion 48 of the first peripheral flange 34 may extend beneath the vertical shield portion 54 of the second peripheral flange 36. A lower edge 58 of the vertical shield portion 54 may be received in abutting contact with the second horizontal shield portion 48 at the flange-to-flange interface 42.

The second horizontal shield portion 48 may terminate prior to contacting a side wall 64 of the enclosure tray 32. A gap 66 may therefore extend between a tip 68 of the second horizontal shield portion 48 and the side wall 64.

The first peripheral flange 34 and the second peripheral flange 36 may be secured together at the flange-to-flange interface 42. In an embodiment, one or more fasteners 60 secure together the lower edge 58 of the vertical shield portion 54 and the second horizontal shield portion 48 at the flange-to-flange interface 42. The fasteners 60 may include spot welds, adhesive, or both, for example.

The gasket seal 38 may be positioned within a pocket 62 that extends between the horizontal shield portion 52 of the second peripheral flange 36 and the second horizontal shield portion 48 of the first peripheral flange 34. The gasket seal 38 may be arranged within the pocket 62 in close proximity to the vertical shield portion 54 of the second peripheral flange 36. The fasteners 60 substantially isolate the pocket 62, and thus the gasket seal 38, from the interior area 26 by blocking the gas path across the flange-to-flange interface 42. Moreover, use of the fasteners 60 enables a boltless arrangement that can substantially eliminate moisture matriculation into the interior area 26 from the ambient environment 40.

An interface between the first horizontal shield portion 46 and the horizontal shield portion 52 may establish a gas path GP in which vent gases from the interior area 26 may escape during a battery thermal event. The vent gases may enter the air gap 56 but are prevented from infiltrating the gasket seal 38 by the fasteners 60.

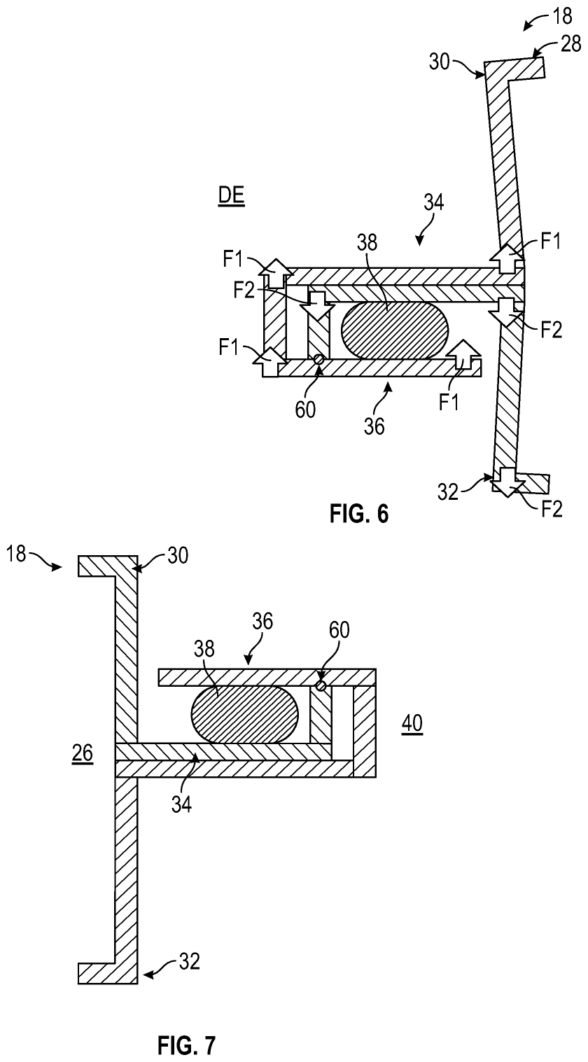

FIG. 6 schematically illustrates a force balancing behavior of the enclosure assembly 28 of the traction battery pack 18 during a deflection event DE. For example, during the deflection event DE, forces F1 acting on the enclosure cover 30 are in an upward direction, and forces F2 acting on the enclosure tray 32 are in an downward direction. As a result, forces that can act on the fasteners 60 are substantially cancelled out, thereby maintaining isolation of the gasket seal 38 during the deflection event DE. Even if the deflection event DE causes a gap between the first peripheral flange 34 and the second peripheral flange 36, the gasket seal 38 may remain isolated by the fasteners 60.

The exemplary traction battery packs of this disclosure incorporate shield features for protecting the integrity of a gasket seal by isolating the gasket seal from gas paths even under high deflection events. The shield features are further configured to provide a boltless arrangement for substantially eliminating moisture from trickling into the interior of the traction battery pack.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly including a first enclosure section and a second enclosure section;
a gasket seal arranged within a pocket between a first peripheral flange of the first enclosure section and a second peripheral flange of the second enclosure section; and
wherein the pocket is isolated from a gas path that extends between the first peripheral flange and the second peripheral flange.

2. The traction battery pack as recited in claim 1, comprising a fastener that isolates the pocket from the gas path.

3. The traction battery pack as recited in claim 2, wherein the fastener includes a spot weld, an adhesive, or both.

4. The traction battery pack as recited in claim 1, wherein the first peripheral flange at least partially envelops the second peripheral flange.

5. The traction battery pack as recited in claim 4, wherein the first peripheral flange includes a first horizontal shield portion, a second horizontal shield portion, and a vertical shield portion that connects between the first horizontal shield portion and the second horizontal shield portion, and the second peripheral flange includes a horizontal shield portion and a vertical shield portion that extends from the horizontal shield portion.

6. The traction battery pack as recited in claim 5, wherein the first horizontal shield portion of the first peripheral flange extends over the horizontal shield portion of the second peripheral flange, and the second horizontal shield portion of the first peripheral flange extends beneath the vertical shield portion of the second peripheral flange.

7. The traction battery pack as recited in claim 6, comprising a fastener that seals a flange-to-flange interface between the vertical shield portion of the second peripheral flange and the second horizontal shield portion of the first peripheral flange.

8. The traction battery pack as recited in claim 5, comprising an air gap between the vertical shield portion of the first peripheral flange and the vertical shield portion of the second peripheral flange.

9. The traction battery pack as recited in claim 8, wherein the gasket seal is arranged on an opposite side of the vertical shield portion of the second peripheral flange from the air gap.

10. The traction battery pack as recited in claim 8, wherein the gas path extends between the first horizontal shield portion of the first peripheral flange and the horizontal shield portion of the second peripheral flange and then into the air gap.

11. The traction battery pack as recited in claim 5, wherein the gasket seal is arranged between the horizontal shield portion of the second peripheral flange and the second horizontal shield portion of the first peripheral flange.

12. The traction battery pack as recited in claim 1, wherein the first enclosure section is an enclosure cover, and the second enclosure section is an enclosure tray.

13. A traction battery pack, comprising:
an enclosure assembly including a first enclosure section and a second enclosure section that cooperate to establish an interior area;
a battery array positioned within the interior area;
a gasket seal arranged between a first peripheral flange of the first enclosure section and a second peripheral flange of the second enclosure section; and
a fastener that isolates the gasket seal from the interior area.

14. The traction battery pack as recited in claim 13, wherein the fastener includes a spot weld.

15. The traction battery pack as recited in claim 13, wherein the fastener includes an adhesive.

16. The traction battery pack as recited in claim 13, wherein the gasket seal is received in a pocket that is isolated from a gas path that extends between the first peripheral flange and the second peripheral flange by the fastener.

17. The traction battery pack as recited in claim 13, wherein the first peripheral flange includes a first horizontal shield portion, a second horizontal shield portion, and a vertical shield portion that connects between the first horizontal shield portion and the second horizontal shield portion, and the second peripheral flange includes a horizontal shield portion and a vertical shield portion that extends from the horizontal shield portion.

18. The traction battery pack as recited in claim 17, wherein the first horizontal shield portion of the first peripheral flange extends over the horizontal shield portion of the second peripheral flange, and the second horizontal shield portion of the first peripheral flange extends beneath the vertical shield portion of the second peripheral flange.

19. The traction battery pack as recited in claim 17, wherein the fastener seals a flange-to-flange interface between the vertical shield portion of the second peripheral flange and the second horizontal shield portion of the first peripheral flange.

20. The traction battery pack as recited in claim 17, wherein the gasket seal is arranged on an opposite side of the vertical shield portion of the second peripheral flange from an air gap that extends between the vertical shield portion of the first peripheral flange and the vertical shield portion of the second peripheral flange.
